(19) United States
(12) Patent Application Publication
(10) Pub. No.: US 2019/0008276 A1
(43) Pub. Date: Jan. 10, 2019

(54) FURNITURE DRIVE

(71) Applicant: Julius Blum GmbH, Hoechst (AT)

(72) Inventor: Christof GOETZ, Lustenau (AT)

(21) Appl. No.: 16/130,376

(22) Filed: Sep. 25, 2018

Related U.S. Application Data
(63) Continuation of application No. PCT/AT2017/060023, filed on Feb. 9, 2017.

(30) Foreign Application Priority Data
Apr. 5, 2016 (AT) A 50274/2016

(51) Int. Cl. A47B 88/46; A47B 88/473; E05F 1/16

(52) U.S. Cl. CPC A47B 88/46; A47B 88/473; E05Y 2900/20; A47B 2210/0091; E05Y 2800/24; E05F 1/16

(57) ABSTRACT

A furniture drive includes a driver for retracting a movable furniture part into a closed position, and the driver is displaceably mounted in sections along a linear travel path and can be detachably coupled to the movable furniture part. A spring device applies force to the driver in a retraction direction, and a damping device damps movement of the driver in the retraction direction. The damping device includes a fluid chamber and a tappet which is displaceably mounted relative to the fluid chamber. A holding device is arranged between the tappet and the driver, and the holding device holds the tappet relative to the driver. The tappet is movable through an opening of the holding device when a force acting upon the driver in the retraction direction is exceeded, whereby the driver can be decoupled from the tappet.

### BACKGROUND OF THE INVENTION

The present invention relates to a furniture drive for retracting a movably-supported furniture part into a closed end position relative to a furniture carcass, comprising:
an entrainment member for retracting the movable furniture part, wherein the entrainment member is displaceably arranged at least over a region along a linear displacement path and which can be releasably coupled to the movable furniture part,
a spring device for applying a force to the entrainment member in a retracting direction,
a damping device for dampening a movement of the entrainment member in the retracting direction, wherein the damping device includes a fluid chamber and a ram displaceably arranged relative to the fluid chamber,
a holding device arranged between the ram and the entrainment member, wherein the holding device holds the ram relative to the entrainment member.

The invention further concerns a drawer pull-out guide comprising a furniture drive of the type to be described.

DE 20 2005 009 860 U1 discloses a closing and retracting device for drawers, in which an entrainment member adapted to be coupled to the drawer is releasably coupled to a spherical head of a coupling rod. The spherical head of the coupling rod thereby engages into a receiving portion of the entrainment member, and the receiving portion of the entrainment member, under the influence of a pulling force exerted to the drawer, expands elastically and thereby releases the spherical head in an overload case. For this overload coupling, there is, however, sufficient space available, because the entrainment member, upon an unduly large pulling force applied to the drawer, moves in the extension direction and thus the distance between the entrainment member and the coupling rod is enlarged.

### SUMMARY OF THE INVENTION

It is an object of the present invention to propose a furniture drive of the type mentioned in the introductory part, in which damages of the furniture drive, in particular of the damping device, can be prevented in an overload case.

According to the invention, it is thus provided that the ram, when a force exertion applied to the entrainment member in the retracting direction is exceeded, can be moved through an opening of the holding device, whereby the entrainment member can be decoupled from the ram.

In other words, the holding device is configured as a linearly operating overload coupling which, when a force exertion to the entrainment member in the retracting direction exceeds a threshold value (i.e. when the movable furniture part is being catapulted with an unduly large manual force or violently slammed towards the closing direction), a decoupling between the entrainment member and the ram is brought about. The ram, upon such an unduly large force application, moves through an opening of the holding device and a continued, destruction-free translational movement of the ram relative to the entrainment member takes place. In this way, the risk of damage (in particular a burst of the damper housing and a leakage of a damping medium as a result of the unduly large pressure application) caused by an entrainment member moving into the furniture carcass can be prevented.

It is preferably provided that the ram, also when a force exertion to the entrainment member in a direction opposite the retracting direction is exceeded, can be moved through a further opening of the holding device, whereby the entrainment member can be decoupled from the ram. In other words, decoupling of the ram from the entrainment member can be effected both in an overload case acting in the retraction direction and also in an extension direction of the entrainment member.

The holding device can include at least one holding element which holds the ram relative to the holding device below a predetermined application of force applied to the entrainment member, and which allows a destruction-free translational movement of the ram relative to the entrainment member above a predetermined application of force applied to the entrainment member. Thereby, it can be provided that the at least one holding element is acted upon by an energy storage member. That energy storage member can be constituted, for example, by a mechanical spring element or, alternatively, by an intrinsic elasticity of the holding element.

The drawer pull-out guide according to the invention comprises a carcass rail to be fixed to a furniture carcass and at least one extension rail displaceably arranged relative to the carcass rail between a closed position and an open position, and a furniture drive of the described type for retracting the extension rail into the closed position.

### BRIEF DESCRIPTION OF THE DRAWINGS

Further details and advantages of the invention will be explained with the aid of the following description of figures; in which:

FIG. 1 shows a perspective view of an item of furniture having a furniture carcass and drawers displaceably arranged relative thereto,

FIG. 2 shows an exemplary embodiment of a furniture drive in an exploded view,

FIG. 3a, 3b show the furniture drive in a side view and in a perspective view,

FIG. 4a, 4b shows a side view of the furniture drive, in which the ram can be decoupled from the entrainment member when a force exertion applied to the entrainment member in a retraction direction is exceeded, and an enlarged detail view thereof,

FIG. 5a, 5b shows a side view of the furniture drive, in which the ram can be decoupled from the entrainment member when a force exertion applied to the entrainment member in a direction opposite the retraction direction is exceeded, and an enlarged detail view thereof.

### DETAILED DESCRIPTION OF THE INVENTION

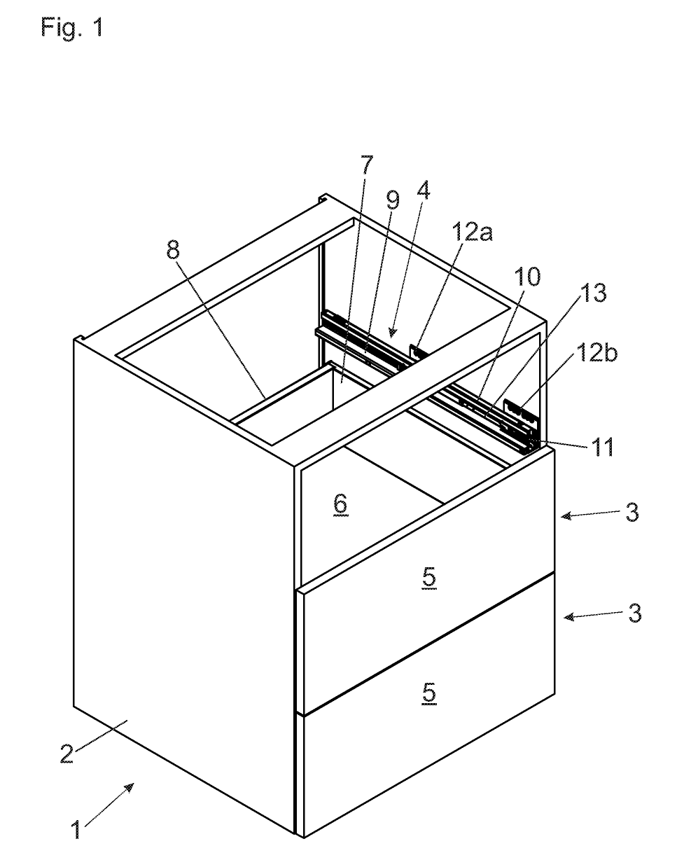

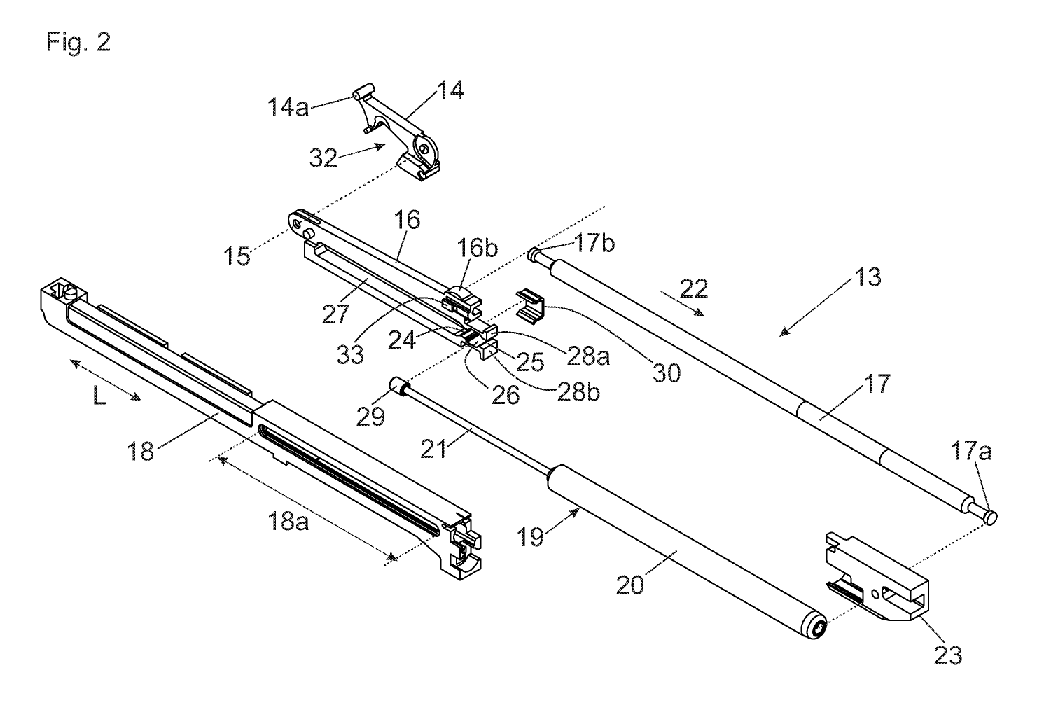

FIG. 1 shows an item of furniture 1 with a cupboard-shaped furniture carcass 2, in which movable furniture parts 3 in the form of drawers are displaceably arranged relative to the furniture carcass 2 by drawer pull-out guides 4. The drawers each have a front panel 5, a drawer base 6, drawer side walls 7 and a rear wall 8. The drawer pull-out guides 4 each have a carcass rail 9 to be fixed to the furniture carcass 2 by fastening portions 12a, 12b, at least one extension rail 10 displaceably arranged relative to the carcass rail 9 and which is to be connected to the drawer side wall 7, and optionally a central rail 11 displaceably arranged between the carcass rail 9 and the extension rail 10 in order for a full extension of the drawer to be realized. The drawer pull-out guide 4 further includes a furniture drive 13 by which the extension rail 10, at the end of the closing movement, can be retracted by a force of a spring device 17 (FIG. 2), and wherein this spring-assisted retraction movement can be decelerated by a damping device 19 of the furniture drive 13.

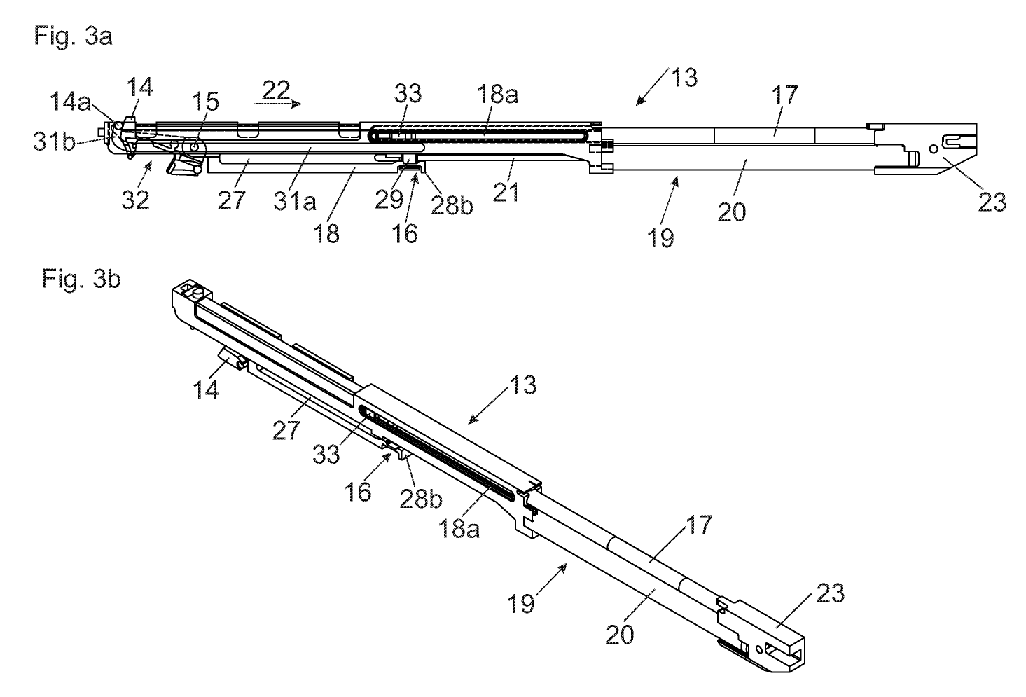

FIG. 2 shows an exemplary embodiment of a furniture drive 13 in an exploded view. The furniture drive 13 includes a housing 18, in which an entrainment member 14 pivotally arranged about a pivoting axis 15 is arranged for releasably coupling to the movable furniture part 3. The entrainment member 14 is displaceably arranged along a linear displacement path 31a (FIG. 3a) extending in a longitudinal direction (L) of the housing 18. For applying a force to the entrainment member 14 in a retraction direction 22, a spring device 17 (preferably with at least one tension spring) is provided by which the entrainment member 14 and the movable furniture part 3 coupled therewith, respectively, can be retracted in the retraction direction 22. The spring device 17 has a first fastening location 17a which, in a mounting position, is connected to a stationary bearing portion 23. The second fastening location 17b of the spring device 17 is connected to a bearing 16b of a holding device 16 which is connected to the entrainment member 14 by a hinge axis 15. The holding device 16 includes at least one guide element 33 by which the holding device 16, together with the entrainment member 14, is displaceably arranged relative to the housing 18 along a guide track 18a. For dampening a spring-assisted retraction movement of the entrainment member 14 in the retraction direction 22, a damping device 19 in the form of a linear damper is provided. The linear damper has a fluid chamber 20 and a ram 21 in the form of a piston rod movable relative to the fluid chamber 20. The fluid chamber 20 is formed within a fluid cylinder which, in the mounting position, is also connected with an end portion to the bearing portion 23. The holding device 16 arranged between the ram 21 and the entrainment member 14 is provided for releasably holding the ram 21 relative to the entrainment member 14, so that the ram 21, when a force exertion applied to the entrainment member 14 in the retraction direction 22 exceeds a threshold value, can be moved through an opening 24 of the holding device 16, whereby the entrainment member 14 can be decoupled from the ram 21.

In the shown figure, the holding device 16 includes two holding elements 28a and 28b which delimit a receiving chamber 26 for accommodating a coupling portion 29 of the ram 21. By an energy storage member 30 which, in the shown embodiment, is configured as a spring clip made of spring steel embracing the two holding elements 28a, 28b, the coupling portion 29 of the ram 21 is held in position within the receiving chamber 26. The coupling portion 29 formed or arranged on the ram 21 has a greater diameter than the ram 21, and the coupling portion 29, during a normal operation (i.e. below a predetermined force exertion applied to the entrainment member 14) is held in the receiving chamber 26 of the holding device 16 and therewith ensures that the coupling between the holding device 16 and the ram 21 is maintained. When a force exertion applied to the entrainment member 14 in the retraction direction 22 is exceeded, the coupling portion 29 of the ram 21 can be moved through an opening 24 of the holding device 16, so that the entrainment member 14 can be decoupled from the ram 21. In the shown embodiment, when a force exertion applied to the entrainment member 14 in the retraction direction 22 is exceeded, the coupling portion 29 can move into a bypass channel 27 of the holding device 16, and a longitudinal direction of the bypass channel 27 extends coaxially to a longitudinal direction of the ram 21. The bypass channel 27 is, however, not mandatorily required. It would also be sufficient to allow the coupling portion 29 of the ram 21 to move from the receiving chamber 26 in an open space being present laterally besides the receiving chamber 26.

On the contrary, when a force exertion applied to the entrainment member 14 in a direction opposite the retraction direction 22 is exceeded, the coupling portion 29 of the ram 21 can move through a further opening 25 of the holding device 16, so that the entrainment member 14 can be decoupled from the ram 21. In the overload case acting in a direction opposite the retraction direction 22 (i.e. upon an unduly large pulling force applied to the movable furniture part 3 in the opening direction), the coupling portion 29 moves out from the receiving chamber 26 into an open space being present laterally besides the receiving chamber 26 and, as a result, the coupling portion 29 subsequently enlarges its distance to the holding device 16. By moving the movable furniture part 3, the entrainment member 14 and the ram 21 can be again moved towards one another, so that the ram 21 again enters the receiving chamber 26 and the coupling between the ram 21 and the holding device 16 is again established.

FIG. 3a shows the furniture drive 13 in a side view, in which the entrainment member 14 arranged within the housing 18 is indicated with a dashed line. The housing 18 includes a linear displacement path 31a for the displaceable support of the entrainment member 14, and a bend 31b adjoining the linear displacement path 31a. The bend 31b is provided for releasably locking the entrainment member 14 is a pre-stressed parking position. The entrainment member 14 is thus movably arranged along the linear displacement path 31a between the shown parking position, in which the spring device 17 is tensioned, and a retracted end position, in which the spring device 17 is substantially relaxed. The entrainment member 14 includes a guide pin 14a by which the entrainment member 14 is displaceably guided along the bend 31b and along the linear displacement path 31a. Moreover, the entrainment member 14, for releasably coupling to the movable furniture part 3, has a notch 32 adapted to be coupled to a coupling peg arranged on the movable furniture part 3. At the end of the closing movement of the movable furniture part 3, the coupling peg moves into the notch 32, so that the entrainment member 14 is tilted out from the shown parking position and is retracted in the retracting direction 22 by the force of the relaxing spring device 17. The entrainment member 14 is pivotally connected to the holding device 16 by the hinge axis 15, and a guide element 33 arranged on the holding device 16 is displaceably arranged along a guide 18a of the housing 18. For dampening the spring-assisted retraction movement, a damping device 19 with a fluid chamber 20 is provided, and the ram 21, upon a movement of the entrainment member 14 in the retracting direction 22, moves into the fluid chamber 20 and the movement of the entrainment member 14 is dampened by a damping fluid arranged within the fluid chamber 20. When the force exertion applied to the entrainment member 14 in the retraction direction 22 is exceeded, the ram 21 is moved through an opening 24 (see FIG. 2) and can move into the bypass channel 27, so that the entrainment member 14 is decoupled from the ram 21. When a force exertion applied to the entrainment member 14 in a direction opposite the retraction direction 22 is exceeded, the coupling portion 29 of the ram 21 is moved through a further opening 25 (see FIG. 2) of the holding device 16, so that the entrainment member 14, upon an unduly large pulling force applied to the movable furniture part 3, can also be decoupled from the ram 21. FIG. 3b shows the furniture drive 13 shown in FIG. 3a in a perspective view.

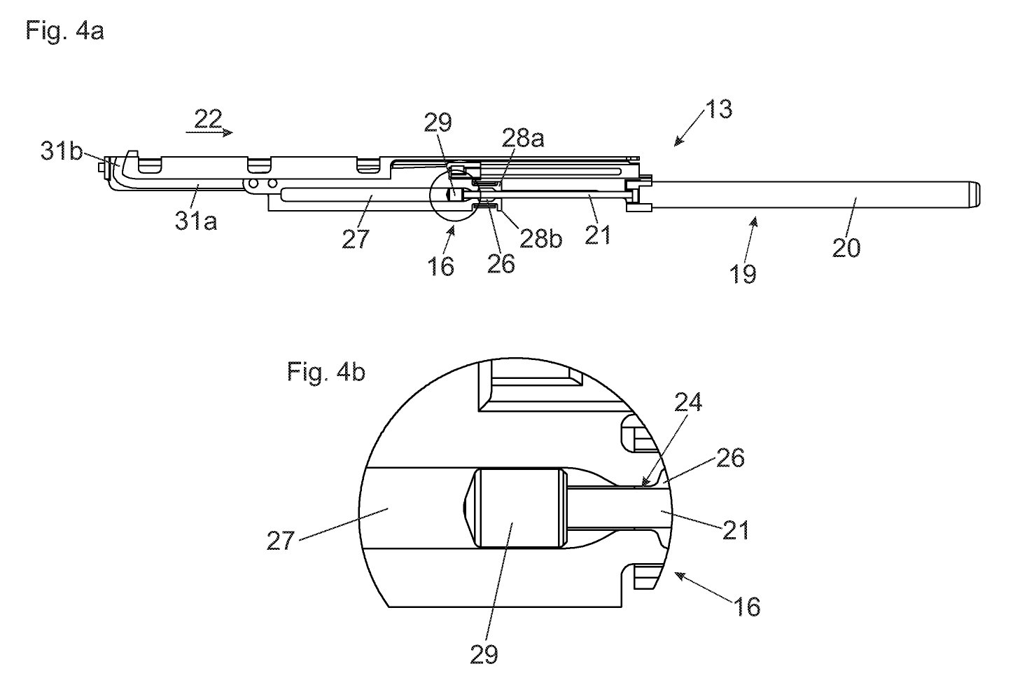

FIG. 4a shows the furniture drive 13 in a side view, in which the ram 21, when a force exertion applied to the entrainment member 14 in the retraction direction 22 is exceeded, is decoupled from the entrainment member 14. By this unduly large force exertion applied to the entrainment member 14 in the retraction direction 22, the coupling portion 29 of the ram 21 has namely been pushed from the receiving chamber 26 through the opening 24 into the bypass channel 27 of the holding device 16, so that the entrainment member 14, without a further relative movement between the ram 21 and the fluid chamber 20, can further be moved in the retraction direction 22. By applying a manual pulling force to the movable furniture part 3, the coupling portion 29 of the ram 21 can be again coupled to the receiving chamber 26 of the holding device 16. FIG. 4b shows the region encircled in FIG. 4a in an enlarged view.

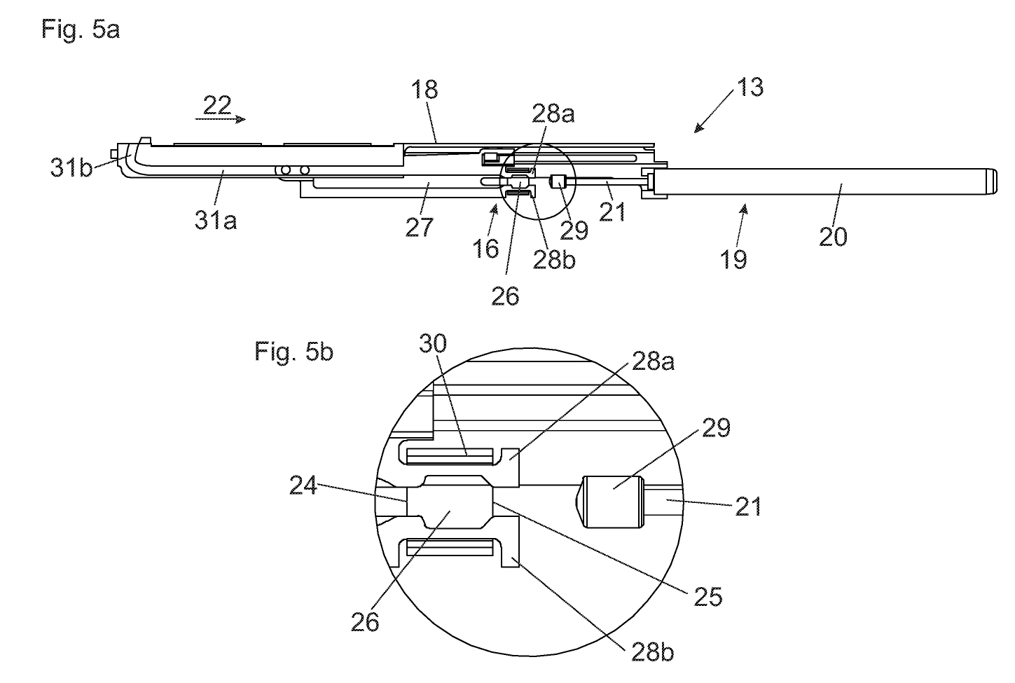

FIG. 5a shows the furniture drive 13 in a side view, in which the ram 21, when a force exertion applied to the entrainment member 14 in a direction opposite the retraction direction 22 is exceeded, is decoupled from the entrainment member 14. By this unduly large force exertion applied to the entrainment member 14 in a direction opposite the retraction direction 22, the coupling portion 29 of the ram 21 has namely been moved from the receiving chamber 26 through a further opening 25 into an open space being present laterally besides the receiving chamber 26, so that the entrainment member 14, without a further relative movement between the ram 21 and the fluid chamber 20, can further be moved in a direction opposite the retraction direction 22 (i.e. in a direction towards the parking position). By applying a manual pushing force to the movable furniture part 3, the coupling portion 29 of the ram 21 can be again coupled to the receiving chamber 26 of the holding device 16. FIG. 5b shows the region encircled in FIG. 5a in an enlarged view.

In the shown embodiment, the two holding elements 28a, 28b are acted upon by an energy storage member 30, and the energy storage member 30 can be formed by a mechanical spring element or also by an intrinsic elasticity of the holding elements 28a, 28b. The holding elements 28a, 28b, when a predetermined force applied to the entrainment member 14 is exceeded, are configured so as to be deformable or bendable in a direction transverse to the longitudinal direction of the ram 21, so that the entrainment member 14 can be decoupled from the ram 21. It is also possible that the elastic pre-stressing of the holding elements 28a, 28 can be adapted so as to be adjustable in a direction towards the coupling portion 29. This, for example, can be effected by an adjusting screw (not shown here), and by rotating the adjusting screw, the pre-stressing of the energy storage member 30 and therewith the releasing force of the holding elements 28a, 28b can be adjusted.

In the shown embodiments, the damping device 19 includes a piston rod displaceable relative to the fluid chamber 20, and the ram 21 is formed by the piston rod. In a kinematic reversal, it is also possible to support the free end of the piston rod in a stationary manner in the mounting position, so that the fluid chamber 20 (i.e. the damping cylinder), for performing a damping hub, can be displaced relative to the stationary piston rod. In this case, the ram 21 is formed by the damping cylinder.

1. A furniture drive for retracting a movably-supported furniture part into a closed end position relative to a furniture carcass, comprising:
an entrainment member for retracting the movable furniture part, wherein the entrainment member is displaceably arranged at least over a region along a linear displacement path and which can be releasably coupled to the movable furniture part,
a spring device for applying a force to the entrainment member in a retracting direction,
a damping device for dampening a movement of the entrainment member in the retracting direction, wherein the damping device includes a fluid chamber and a ram displaceably arranged relative to the fluid chamber,
a holding device arranged between the ram and the entrainment member, wherein the holding device holds the ram relative to the entrainment member,
wherein the ram, when a force exertion applied to the entrainment member in the retracting direction is exceeded, can be moved through an opening of the holding device, whereby the entrainment member can be decoupled from the ram.

2. The furniture drive according to claim 1, wherein the ram, when a force exertion applied to the entrainment member in a direction opposite the retracting direction is also exceeded, can be moved through a further opening of the holding device, whereby the entrainment member can be decoupled from the ram.

3. The furniture drive according to claim 1, wherein the holding device includes at least one holding element which holds the ram relative to the holding device below a predetermined force exertion applied to the entrainment member, and which allows a destruction-free translational movement of the ram relative to the entrainment member above the predetermined force exertion applied to the entrainment member.

4. The furniture drive according to claim 3, wherein the at least one holding element is acted upon by an energy storage member.

5. The furniture drive according to claim 4, wherein the energy storage member is formed by a mechanical spring element or by an intrinsic elasticity of the holding element.

6. The furniture drive according to claim 3, wherein the at least one holding element, above a predetermined force exertion applied to the entrainment member, is configured so as to be deformable or bendable in a direction transverse to the longitudinal direction of the ram, so that the entrainment member can be decoupled from the ram.

7. The furniture drive according to claim 3, wherein the holding device includes at least two holding elements for holding the ram.

8. The furniture drive according to claim 1, wherein the holding device is pivotally connected to the entrainment member by a hinge axis.

9. The furniture drive according to claim 1, wherein the holding device has at least one bypass channel into which the ram can be moved above a predetermined force exertion applied to the entrainment member.

10. The furniture drive according to claim 9, wherein the bypass channel has a longitudinal direction extending coaxially to a longitudinal direction of the ram.

11. The furniture drive according to claim 1, wherein the ram has a free end portion with a coupling portion formed or arranged thereon, wherein the coupling portion, below a predetermined force exertion applied to the entrainment member, is held in a receiving chamber of the holding device.

12. The furniture drive according to claim 1, wherein the furniture drive has a housing with at least one guide, wherein the holding device is displaceably arranged relative to the housing along the guide.

13. The furniture drive according to claim 12, wherein the holding device has at least one guide element displaceably arranged along the guide of the housing.

14. The furniture drive according to claim 1, wherein the damping device includes a piston rod displaceably arranged relative to the fluid chamber, wherein the ram is formed by the piston rod.

15. A drawer pull-out guide comprising a carcass rail to be fixed to a furniture carcass and at least one extension rail displaceably arranged relative to the carcass rail between a closed position and an open position, and the furniture drive according to claim 1 for retracting the extension rail into the closed position.
